(19) United States
(12) Patent Application Publication
(10) Pub. No.: US 2022/0104436 A1
(43) Pub. Date: Apr. 7, 2022

(54) RESILIENT PLANT CONTAINER FORMED FROM PLIABLE MATERIALS

(71) Applicant: Ian Spomer, Lawrence, KS (US)

(72) Inventor: Ian Spomer, Lawrence, KS (US)

(21) Appl. No.: 17/428,419

(22) PCT Filed: Jan. 31, 2020
(86) PCT No.: PCT/US2020/016116

§ 371 Date: Aug. 4, 2021

Related U.S. Application Data
(60) Provisional application No. 62/800,802, filed on Feb. 4, 2019.

(51) Int. Cl. A01G 9/02

(52) U.S. Cl. CPC A01G 9/02

(57) ABSTRACT

A semi-rigid plant container is formed of silicone to provide various semi-rigid, but resilient characteristics. The semi-rigid plant container includes abase having at least one drainage opening and a sidewall. The sidewall rises from the base and presents a top edge, an inner surface, and an outer surface. The inner surface of the sidewall and the base are configured to receive a plant growing media therein. The sidewall is formed substantially of silicone.

### CROSS-REFERENCE TO RELATED APPLICATIONS

This present application claims the priority benefit of U.S. provisional patent application Ser. No. 62/800,802, entitled “RESILIENT PLANT CONTAINER FORMED FROM PLIABLE MATERIALS,” and filed Feb. 4, 2019, incorporated by reference in its entirety herein.

### FIELD OF THE INVENTION

The present disclosure generally relates to planting containers. More specifically, the present disclosure relates to flexible/semi-rigid planting containers.

### BACKGROUND

Traditionally, the majority of planting containers are made of rigid porous materials (such as terracotta) and hard fragile materials (such as plastics). The planting containers of the prior art have numerous problems. For example, terracotta plant containers are heavy and fragile and thus difficult to transport due to breakage. To address these problems, plant pots were made from a number of different materials. These materials have included different varieties of plastic, resins, as well as aluminum, which are also fragile. The overwhelming majority of plant container materials were designed to create a rigid planting container. It is commonly accepted that a flexible plant container made from pliable material is undesirable. For example, compression of the sides of the container could reduce its effective volume leading to spillage. This background discussion is intended to provide information related to the present invention which is not necessarily prior art.

### BRIEF SUMMARY

Embodiments of the invention solve the above-mentioned problems (as well as other problems) by providing a semi-rigid plant container which exhibits the ability to deform and/or be compressed without tearing, breaking, or suffering from fatigue. The semi-rigid plant container is provided with sufficiently rigid sides to prevent undesirable spilling when in use, while remaining flexible enough so as to be foldable and compressible when not in use.

When used in the present invention, the semi-rigidity and flexibility of silicone material differentiates the planting containers described herein from existing planting containers in a number of ways. First, the semi-rigid plant container is pliable, foldable and bendable, so that it can safely be transported, moved within the growing space and replanted without fear of breakage or injury. The semi-rigid plant container weighs significantly less than most of those made from traditional materials, allowing for ease of movement by the user and reduces costs for storage and shipping of the plant pots. Furthermore, the resilient material allows the plant container to easily return to its original shape, absent any appreciable wear or tearing/fatigue to the material, thereby enabling the plant containers to be stored in a smaller space than required by containers formed from rigid materials, or materials that are pliable but will permanently deform or crease when bent. Furthermore, the semi-rigid plant container does not suffer from the breaking concerns presented by traditional terracotta and plastic pots. The semi-rigid plant containers will have a longer usable life span than pots formed from rigid materials. Unlike plant pots formed from plastic or rigid materials, embodiments of the invention may not be subject to deformation due to temperature changes in outdoor applications and are not subject to fading or loss of material integrity due to UV light damage from exposure to sunlight.

In certain embodiments of the present invention, a semi-rigid plant container formed substantially of silicone is provided. The silicone plant container takes the form of round pots, square pots, rectangular pots, patio planters, terra-cotta-like pots in all forms, tree pots, net pots, bulb pans, multi cell containers, propagation pots, self-watering pots, plug flats, deep inserts, rolled rim planters, plant saucers, oval planters, window box planters, or the like.

Further objects, features and advantages of the present invention shall become apparent from the detailed drawings and descriptions provided herein. Each embodiment described is not intended to address every object described herein, and each embodiment does not include each feature described. Some or all of these features may be present in the corresponding independent or dependent claims, but should not be construed to be a limitation unless expressly recited in a particular claim.

A first embodiment of the invention is broadly directed to a plant container including a base having at least one drainage opening and a sidewall. The sidewall rises from the base and presents a top edge, an inner surface, and an outer surface. The inner surface of the sidewall and the base define a cavity configured to receive plant-growing media (and a seed, seedling, plant, or its roots) therein. The sidewall is formed substantially of silicone.

A second embodiment of the invention is broadly directed to a plant container including a base having at least one drainage opening and a sidewall. The sidewall rises from the base and presents a top edge, an inner surface, and an outer surface. The inner surface of the sidewall and the base define a cavity configured to receive plant-growing media (and a seed, seedling, plant, or its roots) therein. The sidewall is formed substantially of silicone. The silicone has a Shore A hardness that is in the range of 40 to 100.

A third embodiment of the invention is broadly directed to a plant container including a first base having at least one drainage opening, a second base having at least one drainage opening, a first sidewall, and a second sidewall. The first sidewall rises from the first base. The first sidewall and the first base define a first cavity configured to receive a first plant-growing media (and a seed, seedling, plant, or its roots) therein. The second sidewall rises from the second base. The second sidewall and the second base define a second cavity configured to receive a second plant-growing media (and a seed, seedling, plant, or its roots) therein. The first sidewall, the second sidewall, the first base, and the second base are each formed entirely of silicone having a Shore A hardness in the range of 40 to 100.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. The present embodiments are not limited to the precise arrangements and instrumentalities shown in the Figures.

FIG. 1 is a perspective view of an exemplary semi-rigid plant container having a circular-shaped base and a single cavity, and including a saucer;

FIG. 2 is a side view of the exemplary semi-rigid plant container of FIG. 1;

FIG. 3 is a side view of the exemplary semi-rigid plant container of FIG. 1, shown without the saucer;

FIG. 4 is a vertical cross-section view of the exemplary semi-rigid plant container of FIG. 1, shown through the 4-4 line of FIG. 3;

FIG. 5 is a top view of the exemplary semi-rigid plant container of FIG. 1;

FIG. 6 is a side view of a first alternative embodiment of a semi-rigid plant container having a square-shaped base;

FIG. 7 is a top view of the alternative embodiment of FIG. 6;

FIG. 8 is a perspective view of a second alternative embodiment of a semi-rigid plant container, presenting multiple cavities;

FIG. 9 is a perspective cross-section view of a third alternative embodiment of a semi-rigid plant container, illustrating a channel between multiple cavities;

FIG. 10 is a top view of a saucer configured to be utilized with the semi-rigid plant container as shown in FIG. 1; and

FIG. 11 is a vertical cross-section view of the saucer of FIG. 10, shown through the 11-11 line of FIG. 10.

The Figures depict exemplary embodiments for purposes of illustration only. One skilled in the art will readily recognize from the following discussion that alternative embodiments of the systems and methods illustrated herein may be employed without departing from the principles of the invention described herein. While the drawings do not necessarily provide exact dimensions or tolerances for the illustrated components or structures, the drawings, not including any purely schematic drawings, are to scale with respect to the relationships between the components of the structures illustrated therein.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments. For instance, the drawing figures do not limit the present invention to the specific embodiments disclosed and described herein. Furthermore, directional references (for example, top, bottom, up, and down) are used herein solely for the sake of convenience and should be understood only in relation to each other. For instance, a component might in practice be oriented such that faces referred to as “top” and “bottom” are sideways, angled or inverted relative to the chosen frame of reference.

### Exemplary Plant Containers

Embodiments of the invention are directed to a semi-rigid plant container 100. The semi-rigid plant container 100 may be at least partially formed of silicone or other semi-rigid material, as discussed in depth below. The semi-rigid plant container 100 may take any of numerous shapes and forms. Exemplary embodiments of the semi-rigid plant container 100 are shown in the figures and discussed in more depth below.

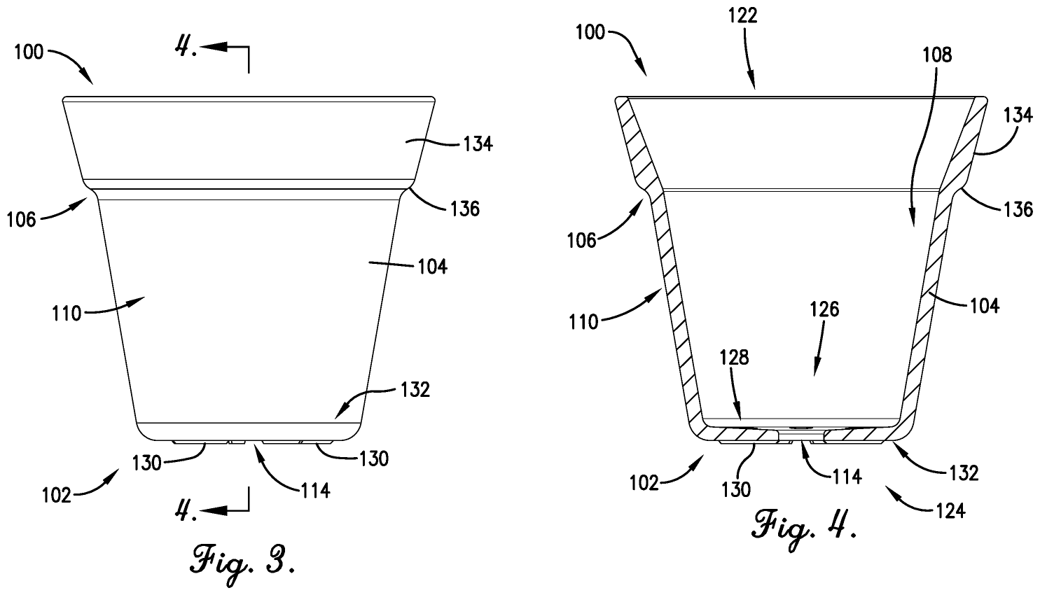

Turning to the figures, the semi-rigid plant container 100 includes at least one base 102 and at least one sidewall 104. The base 102 is best shown in FIGS. 3 and 4. The sidewall 104 rises from the base 102 and presents a top edge 106, an inner surface 108, and an outer surface 110. The sidewall 104 and the base 102 may be provided in any of various shapes and orientations, examples of which are shown in the figures. The inner surface 108 of the sidewall 104 and the base 102 define a cavity 112 configured to receive a plant therein. The sidewall 104 and the base 102 provide structural stability for the plant, dirt, and other material within the cavity 112. The semi-rigid plant container 100 may include a drainage opening 114 (or a plurality of drainage openings, not shown) configured to allow drainage of liquid (such as water) from the plant, dirt, and other material within the cavity 112. In other words, the aperture of the drainage opening 114 extends through the entire thickness of the sidewall or base.

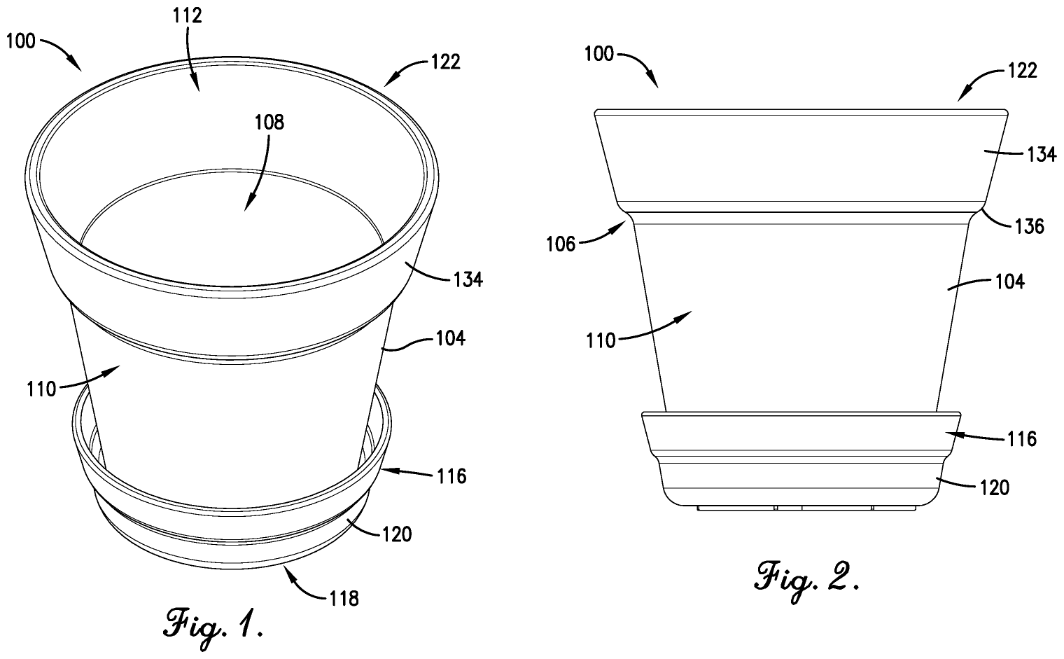

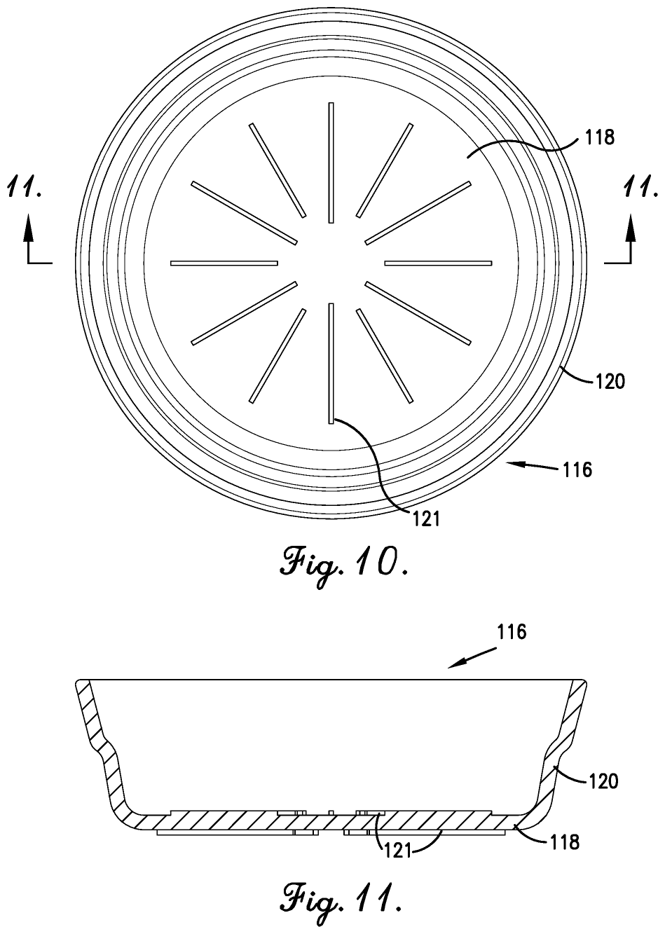

As best shown in FIGS. 1 and 2, in some embodiments, the semi-rigid plant container 100 includes a saucer 116. The saucer 116 is configured to catch excess liquid and other debris from the semi-rigid plant container 100. The base 102 of the semi-rigid plant container 100, of some embodiments, presents the drainage opening 114 configured to drain excess liquid. The saucer 116 collects the drained liquid from which the liquid may evaporate and/or keep the liquid in contact with the soil and the plant at the bottom side of the semi-rigid plant container 100. The saucer 116 is shown in FIGS. 1 and 2 being disposed below the semi-rigid plant container 100. The saucer is shown alone in FIGS. 10 and 11, from a top view and a vertical cross-section view, respectively. The saucer 116 may include a saucer base 118 and a saucer sidewall 120. The saucer base 118 may include saucer protrusions 121 which extend upwardly and/or downwardly as best shown in FIGS. 10 and 11. The saucer protrusions 121 increase friction between the saucer 116 and an underlying surface (not illustrated) and/or between the saucer 116 and the base 102 of the semi-rigid plant container 100. The saucer sidewall 120 may present a general conical frustum shape and be of a size configured to receive the base 102 of the semi-rigid plant container 100 therein. The saucer 116 may be formed of the below-discussed silicone or other semi-rigid material, or may be formed of traditional materials.

The saucer 116 is configured to be disposed under the base 102. In some embodiments, not illustrated, the saucer 116 may be a permanent component of the base 102. In these instances, the saucer 116 may be monolithic or integrally formed with the base 102 or otherwise permanently attached (such as via a chemical adhesive). Thus, in either embodiment, the saucer 116 is configured to capture said drained excess liquid from the drainage opening 114 and accordingly, the saucer base 118 is preferably free of drainage holes. The geometric shape of the saucer may correspond to the shape of the plant container base (e.g., circular container and circular saucer, or square saucer with square container). Alternatively, the saucer may have a different geometric shape than the corresponding plant container (e.g., square saucer with round container). In either case, the saucer 116 has a cross-sectional dimension (e.g., diameter) that is larger than the corresponding cross-sectional dimension (e.g., diameter) of the corresponding plant container base 102, such that the plant container base 102 can be received within the saucer sidewall 120.

Turning to FIGS. 1-4, a first embodiment of the semi-rigid plant container 100 is shown. The first embodiment has a generally flat, circular shaped base 102 with a cylindrical sidewall 104. The first embodiment presents a general conical frustum shape. The conical frustum shape presents an opening on a top side 122 and is substantially closed on a bottom side at the base 102 (less the drainage opening 114 to allow for drainage). The open end at top size 122 is configured to receive plant-growing media in the cavity 112, as well as seed(s), seedling(s), plant(s), or their root(s). Suitable plant-growing medium includes, without limitation, topsoil, potting soil, clay/dirt, perlite, manure, compost, vermiculite, sand, peat moss, and combinations thereof.

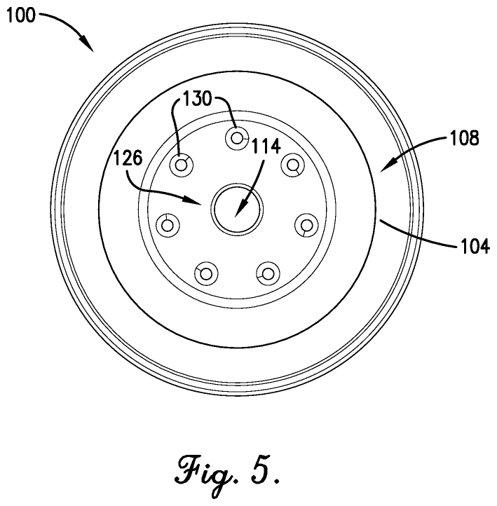

The base 102 of embodiments presents a generally flattened circular shape. The base 102 may include a plate having the drainage opening 114 disposed therein. The drainage opening 114 may be disposed in a central segment 126 of the base 102, as best illustrated in FIGS. 4 and 5. In some embodiments, the drainage opening 114 is configured to be utilized with rocks, gravel, or marbles, or other recognized drainage systems in the art. The drainage opening 114 of embodiments is configured such that if liquid were added to the empty plant container, the liquid would drain from the bottom or side of the container before the container could be filled. Likewise, if the container is set in liquid, the liquid may enter the container from the bottom through drainage opening 114. In other words, the plant container 100 is designed such that it will not be tight to liquids and will not hold water or other liquid. Different plants have different drainage requirements and the means for drainage can be adjusted according to the type of plant potted in the semi-rigid plant container 100, the type of soil or growth medium selected, etc. In other embodiments, the drainage opening 114 may be disposed toward or against the sidewall 104, such as illustrated with regard to another embodiment in FIG. 9. In still other embodiments, the drainage opening 114 may be disposed in another location relative to the base 102 and the sidewall 104. Again, certain embodiments employ a single drainage opening 114, while other embodiments may include a plurality of drainage openings 114.

In some embodiments, as best shown in FIG. 4, the base 102 presents an inner surface 128 that is sloped downward toward the drainage opening 114. The sloping inner surface 128 facilitates the drainage of the liquids from the semi-rigid plant container 100, by preventing pooling of liquid along the base 102. The base 102 of these embodiments may include a substantially flat outer surface 110 such that the base 102 is thinner towards the drainage opening 114 than away from the drainage opening 114. The sloping inner surface 128 may also include an inner beveled interface between the base 102 and the sidewall 104. The inner beveled interface also facilitates the drainage of the liquid from the semi-rigid plant container 100 by directing liquid toward the drainage opening 114.

The base 102 may also present gripping protrusions 130 therefrom, as best illustrated in FIGS. 3, 4, and 6. The gripping protrusions extend downward from the base 102 to increase the friction between the base 102 and an underlying surface. The gripping protrusions 130 in contact with the underlying surface keeps the base 102 (and by extension, the semi-rigid plant container 100) laterally stable relative to the underlying surface.

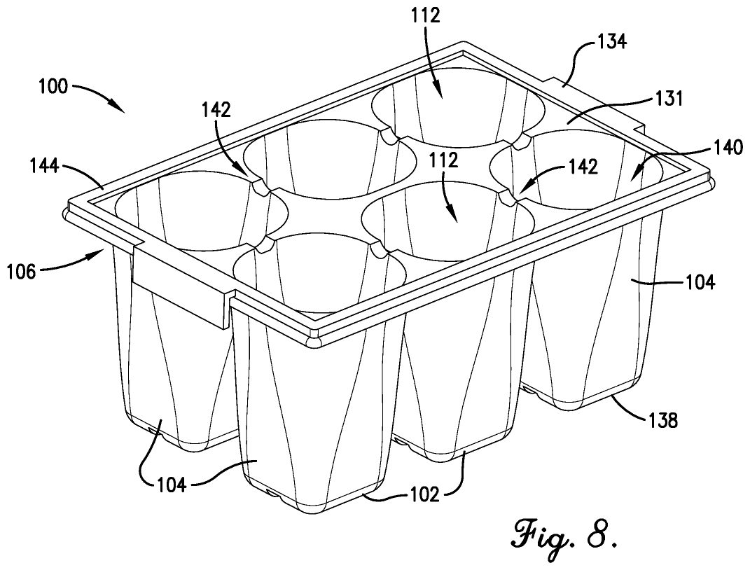

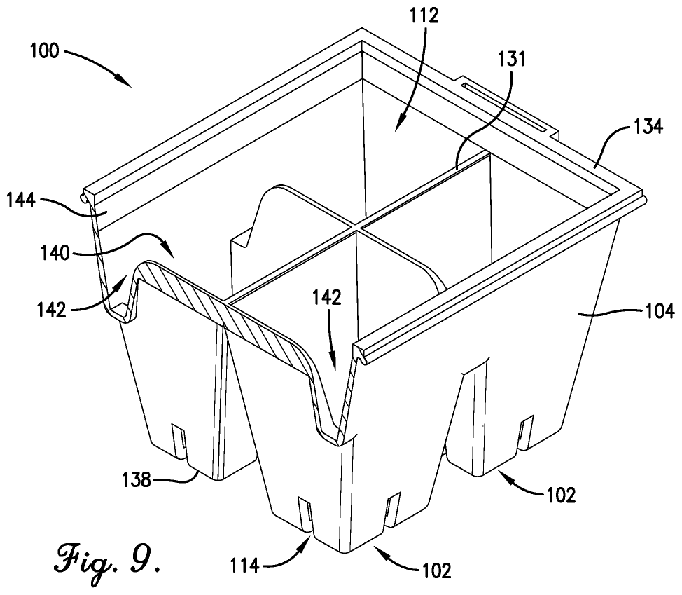

The sidewall 104 rises from the base 102. The sidewall 104 provides lateral support to the plant, soil, and other materials in the semi-rigid plant container 100. In some embodiments, the sidewall 104 fully surrounds the base 102, such as in FIGS. 1-5. In other embodiments, the semi-rigid plant container 100 includes multiple sidewalls 104 that are joined at sidewall intersections 131 (such as illustrated in FIGS. 8 and 9). The sidewall 104 presents the top edge 106, a bottom edge 132, the inner surface 108, and the outer surface 110. The top edge 106 forms the cavity 112. The bottom edge 132 is connected to the base 102, as illustrated in FIG. 3. The inner surface 108 is disposed into the cavity 112. The outer surface 110 is disposed outwardly, such as to interface with the outside environment, be gripped by a user, and the like.

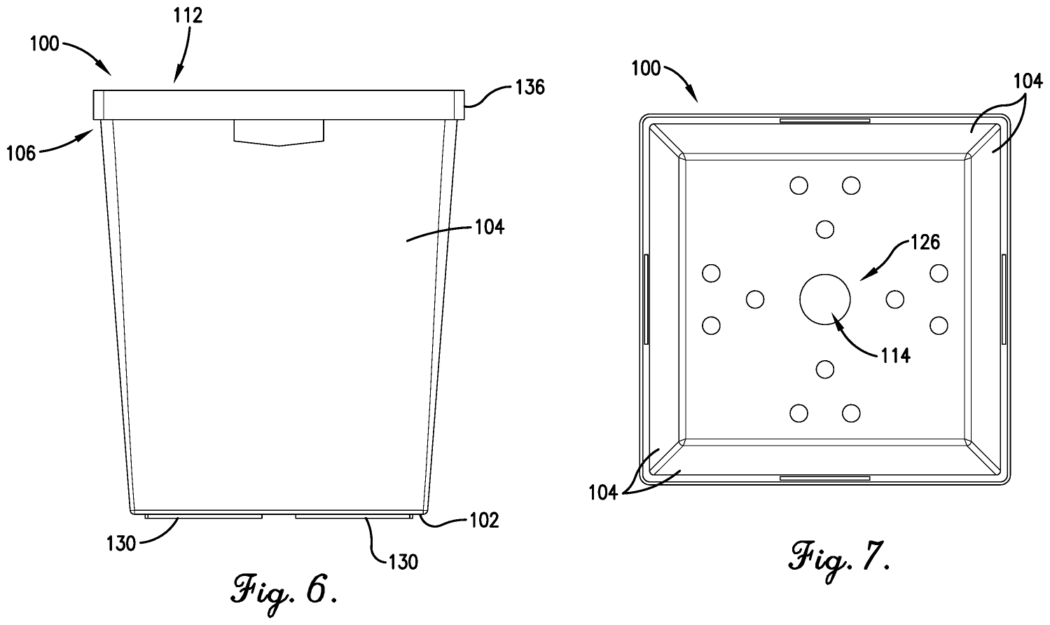

In some embodiments, the sidewall 104 presents a conical frustum shape when viewed from an exterior side, as best illustrated in FIG. 1. The sidewall 104 of embodiments may present a substantially constant thickness, as best shown in FIG. 4. Thus, in these embodiments, the cavity 112 also presents a substantially conical frustum shape. In other embodiments, the sidewall 104 may present a varied thickness, such as to provide additional structural support at weak locations. In other words, the sidewall 104 may be thicker in some regions than in other regions. In still other embodiments, the sidewall 104 presents a generally cylindrical shape. In yet still other embodiments, the sidewall 104 presents a pyramidic frustum shape, such as illustrated in FIGS. 6 and 7. In yet still other embodiments, the sidewall 104 presents another shape, such as illustrated in FIGS. 8 and 9, which may be a complex shape configured to form multiple cavities, as discussed below.

In embodiments of the invention, the base 102 is monolithic or integrally formed with the sidewall 104. This is best illustrated in FIG. 4, in which it can be seen that the base 102 is unity with the sidewall 104, such as by being originally manufactured as a single unit. This reduces the likelihood of failure (such as cracking) at the intersection between the sidewall 104 and the base 102 and eases manufacturing.

In embodiments of the invention, the sidewall 104 includes an annular rim 134 disposed at the top edge 106 of the sidewall 104, as best shown in FIGS. 2 and 3. The annular rim 134 may increase the thickness and/or the angle of the sidewall 104 relative to the base 102. The increased thickness increases the strength of the annular rim 134, which is a common failure point for traditional pots. The increased angle relative to the base 102 (e.g., making the opening of the cavity 112 larger than if the sidewall 104 continued) allows for easier access to the cavity 112 as well as removal of the plant therefrom. This also increases the surface area of the soil that is disposed within the cavity 112, increasing the amount of water captured in the cavity 112 for use in growing the plant. The annular rim 134 may include a radial protrusion 136. The radial protrusion 136 is configured to aid in gripping and stacking of the semi-rigid plant container 100. In embodiments of the invention, best illustrated in FIG. 4, the annular rim 134 is monolithic with the sidewall 104. In some embodiments, the annular rim 134 may surround multiple cavities, such as illustrated in FIGS. 8 and 9.

Turning to FIGS. 8 and 9, in some embodiments the semi-rigid plant container 100 includes a second base 138 distinct from the base 102. The sidewall 104 defines a second cavity 140 relative to the second base 138. The second cavity 140 may be configured to receive a second plant (not illustrated) therein. The first plant and the second plant may be seedlings configured to be transplanted to another, larger semi-rigid plant container 100 (such as the embodiment shown in FIGS. 1-5, or the embodiment shown in FIGS. 6-7) or into the ground upon growing to a sufficient size. In the embodiment of FIG. 8, six cavities are presented such that six seedling plants may be grown simultaneously. In the embodiment of FIG. 9, four cavities are presented in the figure, of an embodiment which may include six or more cavities.

The sidewall 104 may present a communicative channel 142 between the first cavity 112 and the second cavity 112, as best shown in FIGS. 8 and 9. The communicative channel 142 allows liquid to flow between the first cavity 112 and the second cavity 112. This is best shown in FIG. 9. The communicative channel 142 keeps the first plant and the second plant more evenly watered than if the first cavity 112 and the second cavity 112 were fully separated. The annular rim 134 of these embodiments may include a raised segment 144 to also allow for liquid to flow between the first chamber and the second chamber.

The semi-rigid plant container 100 may be provided in any of numerous sizes. The embodiments shown in FIGS. 1-5 is in the exemplary form of a quart sized round pot. The annular rim 134 defines the opening to a cavity 112 which is formed by the base 102 and sidewall 104. The cavity 112 is sized so as to provide the capacity for approximately one quart of planting material. Furthermore, in certain embodiments, the semi-rigid plant container 100 has a base 102 which is circular in shape and has a diameter of between about 2.5 and 14 inches. Additionally, the vertical height of container, and thus also the sidewall 104, is between about 3 and 18 inches. It should be appreciated that the forgoing, along with the below Tables, are merely exemplary and that other sizes and shapes may be utilized within the scope of the invention.

As illustrated in FIG. 4, the sidewall 104 may have a thickness of approximately 3/16 inch which is sufficient to provide the appropriate Shore hardness (stiffness of material). The sidewall 104 should be both rigid enough to maintain its shape when gripped, yet soft enough to exhibit its functional durability and pliability (thus “semi-rigid”). Alternatively, in certain other embodiments, the thickness of the sidewall 104 may be between 1/16 and ½ inch, depending upon the desired rigidity. As will be appreciated by those of skill in the art, other thicknesses are contemplated and should be considered within the scope of the present invention. Furthermore, the thickness and Shore hardness of the materials utilized will vary depending on the particular shape, size and overall design of the semi-rigid plant container 100 desired. For example, a taller pot with a larger volume, such as a patio planter would require silicone with a more rigid profile to properly maintain its shape than would be required for a much smaller starter pot.

Exemplary pot sizes and dimensions are provided in the tables below. Table 1 shows the dimensions in base 102 and top sizes, with the measurements being approximate to within +/−25%. Table 2 shows the pots in “gallon sizes”—size ranges can vary +/−25% depending upon desired characteristics.

TABLE 1

| Pot | | Pot Diameter | | | Pot Diameter | | | | | |
|---|---|---|---|---|---|---|---|---|---|---|
| Size | | (Top) | | | (Base) | | | Pot Height | | |
| 9 | cm | 9.0 | cm | 3.5″ | 6.0 | cm | 2.5″ | 8.5 | cm | 3″ |
| 1 | Liter | 13.0 | cm | 5″ | 10.0 | cm | 4″ | 11.0 | cm | 4″ |
| 2 | Liter | 17.0 | cm | 6.5″ | 12 | cm | 4.5″ | 13.0 | cm | 5″ |
| 3 | Liter | 19.0 | cm | 7.5″ | 13 | cm | 5″ | 15.0 | cm | 6″ |
| 4 | Liter | 20.0 | cm | 8″ | 15.5 | cm | 6″ | 16.5 | cm | 6.5″ |
| 5 | Liter | 22.5 | cm | 9″ | 16.5 | cm | 6.5″ | 18.0 | cm | 7″ |
| 7 | Liter | 25.0 | cm | 10″ | 19.0 | cm | 7.5″ | 20.0 | cm | 8″ |
| 10 | Liter | 28.0 | cm | 11″ | 24.0 | cm | 9.5″ | 22.5 | cm | 9″ |
| 15 | Liter | 33.0 | cm | 13″ | 25.5 | cm | 10″ | 30.0 | cm | 12″ |
| 20 | Liter | 35.5 | cm | 14″ | 27.5 | cm | 11″ | 32.5 | cm | 13″ |
| 25 | Liter | 38.5 | cm | 15″ | 30.0 | cm | 12″ | 35.0 | cm | 14″ |
| 30 | Liter | 41.0 | cm | 16″ | 33.0 | cm | 13″ | 36.0 | cm | 14″ |
| 40 | Liter | 50.0 | cm | 20″ | 35.5 | cm | 14″ | 45.0 | cm | 18″ |

TABLE 2

| Pot Size | Pot volume | |
|---|---|---|
| 4″ | pint (0.5 quart) | |
| 5-6″ | quart (0.25 gallon) | |
| 7-8″ | 1 | gallon |
| 8.5″ | 2 | gallons |
| 10″ | 3 | gallons |
| 12″ | 5 | gallons |
| 14″ | 7 | gallons |
| 16″ | 10 | gallons |
| 18″ | 15 | gallons |
| 24″ | 25 | gallons |
| 30″ | 30 | gallons |

For ease of removing plants, the sidewall 104 that extends from the base 102 to the top lip of the annular rim 134 is angled such that the diameter of the bottom of the container is slightly smaller than the diameter of the top opening, as discussed above in reference to the frustum shape. As shown in Table 1, the dimensions of the base 102 and top can vary, and thus the angle of the sidewall 104 can also vary. However, in certain embodiments, the sidewall 104 is designed so as to have an angle between the sidewall 104 and surface (upon which the base 102 sits) of about 85° to about 60°, preferably about 80° to about 70°.

### Exemplary Materials

Exemplary materials, from which various embodiments of the invention may be formed, will now be discussed in more detail. Regardless of the shape or size, as discussed above, embodiments of the invention are manufactured principally, or at least substantially (at least 50%, preferably at least 60%, preferably at least 70%, preferably at least 75%, preferably at least 80%, preferably at least 85%, preferably at least 90%, preferably at least 95%, preferably at least 98%, preferably at least 99% by weight) of silicone. In some embodiments, the entire semi-rigid plant container 100 may be formed of a single unitary segment of silicone. In other embodiments, the semi-rigid plant container 100 may be formed as a composite of two or more materials. As an example, the sidewall 104 and the base 102 may be formed of silicone and the annular rim 134 may be formed of a plastic. As another example, the sidewall 104 and the base 102 may be formed of silicone surrounding an internal mesh or other internal support structure. The semi-rigid plant container 100, according to the illustrated embodiment, is preferably formed principally or entirely from silicone. The semi-rigid plant container 100 may be formed by suitable manufacturing methods such as injection molding, liquid injection molding, extrusion molding, compressing molding, transfer molding, 3D printing, and the like. Silicone is a low taint, non-toxic material, which meets the necessary FDA requirements when contact with food is required.

The various components of the semi-rigid plant container 100 formed of silicone (such as the sidewall 104, the base 102, and/or the annular rim 134) are pliable, flexible, elastic, and resilient, so as to return to an original shape upon deformation thereof, without permanent deformation or creasing. This allows for easy removal of the plant and prevents permanent damage to the semi-rigid plant container 100 upon dropping or striking of the semi-rigid plant container 100.

The semi-rigid plant container 100 may include any of various characteristics of a “resilient” material as that term is used herein: it is dishwasher safe, resistant to deformation or breakdown at temperatures between −148° F. and 600° F., resistant to breakdown from UV light, resistant to fungal and bacterial growth, flexible, foldable, non-toxic, and (under normal circumstances) unbreakable. The term “resilient” also includes materials resistant to hardening, cracking, tearing, peeling, crumbling, drying out, rotting, and/or becoming brittle over time. It should be appreciated that the above-discussed characteristics and advantages may be present only in some embodiments of the invention. Some embodiments of the invention may have fewer characteristics while still being within the scope of the invention. Thus, a resilient material may have any, all, or some combination of the above discussed characteristics, or other such characteristics as would be understood by one having ordinary skill in the art. However, at a minimum, the semi-rigid material of the invention has the core characteristic of being pliable and resilient, such that it is bendable but will return to its original shape upon decompression without any permanent deformation, cracking, or tearing.

The Shore hardness value (as measured by durometer) of the semi-rigid plant container 100 material will vary depending on the type, size, and use of the semi-rigid plant containers 100. For larger pots used for growing plants to full maturity, a high Shore rated silicone can be used. For example, in certain embodiments the material can have a Shore A value of at least about 40, preferably from about 40 to about 100, more preferably about 60 to about 90. The Shore value of the material can be adjusted for a number of factors. For example, the semi-rigid plant container 100 may have a relatively wide wall thickness (such as shown in FIG. 4) in which case a relatively lower Shore rated material can be used to achieve a similarly ridged side wall of that of a high Shore rated material with a thinner wall (such as shown in FIGS. 8 and 9). The semi-rigid plant container 100 may thus be customized to be more malleable based upon the application, then a lower Shore rating can be used, and the material thickness can be adjusted to achieve similar goals.

In the case of semi-rigid plant containers 100 including multiple cavities (such as illustrated in FIGS. 8 and 9), such as 6-pack starter containers, seed flats, and smaller pots used for seed starting, a lower Shore rating may be utilized. This is due to the fact that the pot needs to be able to be manipulated more easily to allow for the starter plants to come out more easily. In certain such embodiments, the material can have a Shore A value of about 20 to about 80, preferably about 30 to about 60. But depending on the use of the semi-rigid plant container 100, a higher Shore rated silicone may be used for specific plant container applications.

The semi-rigid plant container 100 of embodiments of the invention is resistant to environmental and industrial factors that damage traditional pots allowing it to be used in harsher environments than traditional plant pots without breakdown or contamination. The semi-rigid plant container 100 is resistant to degradation at higher levels of radiation than rigid or plastic pots. The semi-rigid plant container 100 is resistant to Ozone degradation, oxidation and degradation from chemicals including water, isopropyl alcohol, some acids, oxidizing chemicals and ammonia even at elevated temperatures.

In some embodiments, the inner surface 108 of the container may be smooth to allow easy cleaning and decrease the likelihood of cross contamination upon repotting. Although not shown, it shall be appreciated that many different textures and patterns may be applied to the outside of the sidewall 104 and/or the remaining portions of the container, such as to enhance its grip-ability, aesthetics, or to include a design element.

In other embodiments, other pliable materials may be utilized without departing from the scope of the invention. It shall be appreciated that any of a group of semi-inorganic polymers based on the structural unit R₂SiO, where R is an organic group, characterized by wide-range thermal stability, high lubricity, extreme water repellency, and physiological inertness can be considered in the silicone family of products.

In certain embodiments, the semi-rigid plant container 100 may be formed of a composite material that includes copper. The copper may be incorporated into the base silicone or other material. For example, in certain embodiments, the silicone material is infused with copper sulfates.

The use of silicone materials provides for a large versatility in design. One of those design elements is the ability to put drainage holes or slots anywhere desired in a pot. Some pots can be designed to have very quick and complete drainage, so multiple holes in the bottom of the semi-rigid plant container 100 will be an ideal placement. Other pots may need to have holes placed in the sides for different reasons. A smaller square pot or 6 pack containers may need holes in the side of the semi-rigid plant container 100 because the base 102 is too small to incorporate holes and still have the strength needed. The side wall holes can be sized to accomplish any type of drainage requirements. Additionally, plant containers could be made to have no holes in the sides if a type of plant desires little to no drainage. Drainage openings 114 could also be designed to have holes drilled in them if a hole is desired later on, if the type of plant is changed and drainage requirements change. The use of silicone material also allows for smaller holes, in greater numbers, to be used than traditional plant container materials, thereby allowing for superior drainage characteristics.

Furthermore, the semi-rigid plant containers 100 may be customized or personalized, such as by the inclusion of a logo, identifier, or other decorative element. The properties of silicone allow the ability to apply printed or embedded physical logos to the outside surface or any other surface of the semi-rigid plant container 100. Using appropriate inks and processes, these products can receive a variety of designs, and be used as retail housewares and promotional products.

Additionally, the silicone utilized can be produced in any Pantone color, or without pigment so as to be rendered nearly translucent. Embodiments of the invention may include an additive that renders the finished pot phosphorescent (i.e., glow in the dark). Thus, in some embodiments, the sidewall 104 and/or the base 102 of the semi-rigid plant container 100 is substantially translucent, substantially transparent, substantially phosphorescent, or having some other visual property.

In some embodiments, the silicone may be provided with a certain color. There are a number of advantages to being able to color silicone to any color including being able to make it clear. First, the semi-rigid plant containers 100 could be separated by color to keep better organization for commercial growers and the home grower alike. Additionally, the semi-rigid plant containers 100 could be made to be black to be used to collect more sun light in cooler weather to warm the roots of pots. The ability to be able to make the semi-rigid plant containers 100 clear (e.g., transparent and/or translucent) allows for the root growth to be monitored. So, if the roots start to reach the side walls of the semi-rigid plant container 100, these plants can be identified and transplanted to new pots so not to become root bound. The semi-rigid plant containers 100 ability to be colored to any color additionally allows individuals to pick their color palette to fit a theme or color pattern for to accomplish design goals in architecture or interior design.

In some embodiments, the semi-rigid plant container 100 may be made highly transparent without the yellow cast seen in current clear pots. The ability of the semi-rigid plant container 100 to be made completely or substantially transparent gives it the capability to grow varieties of plants such as epiphytes or air plants and some orchids that thrive on exposure to light. This is also applicable in the California-style of plant starting, allowing the grower to see into the semi-rigid plant container 100 and determine water needs. The transparent nature of the semi-rigid plant containers 100 allows the grower to see if the plant roots have reached the side walls and if transplantation is needed. Silicone rubber colors are silicone-based and certain tones from the RAL color chart and/or Pantone color chart are available ready-to-use. In addition, colors can be mixed by following available formulas, if the ready-to-use tones are not suitable.

In some embodiments, the semi-rigid plant container 100 is made of a food-grade material (such as food-grade silicone) with little-to-no off-gassing and is hypoallergenic. The semi-rigid plant container 100 is uniquely suited for those with allergies or sensitivities to materials used in traditional plant pots. The semi-rigid plant container 100 may be used to grow food with little-to-no risk of adverse reactions for those with allergies. In some instances, the silicone materials are generally biologically neutral or inert to most plants, and thus the material of the semi-rigid plant container 100 does not negatively impact seed germination or seedling growth. In some embodiments, the semi-rigid plant container 100 is fully recyclable which reduces landfill space used by current plant pots, which typically cannot be recycled. In other embodiments, the semi-rigid plant container 100 is formed of a non-food-grade material (such as a non-food-grade silicone).

Silicone also has a higher oxygen transfer rate when compared to rubber, as well as an improved coefficient of friction. Silicone gas permeability is approximately 400 times that of rubber. The coefficient of friction of silicone rubber ranges from less than 0.25 to more than 0.75. Steel is about 0.10. Compared to steel silicone rubber is 2 to 7 times greater. Lower durometers have higher coefficients. The texture can be used to increase the co-efficient of friction. Polished surfaces have a lower coefficient of friction. Texture raises the coefficient of friction. The ability to customize the coefficient of friction easily may be an advantage of utilizing silicone for the semi-rigid plant container 100. Silicone is also lime and dirt repellant, which is a benefit when trying to keep the semi-rigid plant containers 100 clean.

In some embodiments, the inner surface 108 and the outer surface 110 each present distinct textures. In these embodiments, the inner surface 108 presents a first texture and the outer surface 110 presents a second texture. The first texture is distinct from the second texture. As an example, the first texture may have a lower coefficient of friction than the second texture. Thus, the second texture is configured to allow for gripping of the outer surface 110, and the first texture is configured to allow for easy cleaning to facilitate reuse of the semi-rigid plant container 100 (as discussed below).

In summary, silicone rubber may have any of numerous exemplary advantages, such as bacterial resistant, fungal resistant, UV stability, high elongation rate, structural stability, safe for dishwasher usage, fire resistance, lime and dirt repellence, temperature stability, oxygen permeability than plastics, recyclable, retains shape after flexing, ozone and oxidation resistance, and/or weather resistance.

### Exemplary Uses

The semi-rigid plant container 100 is configured to be replanted and reused over a significantly longer period of time. The semi-rigid plant container 100 has increased capacity to withstand environmental factors and can be cleaned and replanted without damaging the semi-rigid plant container 100. Existing plant pots of plastic and rigid materials are subject to becoming brittle and prone to breakage due to changes in temperature and are typically stored in climate-controlled environments for maximum usable life span. Plant pots created from rigid materials are generally porous. The porous nature of the rigid plant pots allows water to infiltrate the material and with decreases in temperatures, the rigid plant pot is subject to cracking and breakage. Embodiments of the semi-rigid plant container 100 are resistant to temperature changes from −148 to 600 degrees Fahrenheit without damage to the materials and is resistant to infiltration of water. This allows the semi-rigid plant container 100 to be stored without climate control which allows for easier and less expensive storage options. Further, the semi-rigid plant container 100 can be buried in the ground through all seasons over multiple years with little to no damage, which allows for increased flexibility in how the semi-rigid plant container 100 may be utilized.

Cleaning current plant pots for reuse with new plants presents difficulties in decreased longevity of the materials and potential for contamination of new potted materials. Plastic pots cannot be cleaned in a dishwasher as the heat causes the plastic to become brittle and/or warped contributing to breakage or cracking within several washings. Using silicone allows a user to sterilize with any of various cleaning and sterilization methods. Due to the high temperature ranges capable in silicone, sterilization can be achieved with methods including boiling for 10 minutes, cleaning in a dishwasher, and heating in an oven above 165 degrees Fahrenheit for most bacteria and molds, with the capability to heat as high as 600 degrees Fahrenheit to kill any applicable mold or bacteria. The silicone material is also able to be sterilized in an autoclave which heats to around 250 degrees Fahrenheit. With the extreme temperature capabilities, the semi-rigid plant containers 100 of the present invention can be sterilized in all these ways with ease and exhibit no degradation of the material. Additionally, the high resistance to chemicals would allow for sterilization with chemicals such as isopropyl alcohol, hydrogen peroxide and hydrogen superoxide.

Additionally, plant pots of rigid materials are heavy and cannot be cleaned in a dishwasher easily due to weight and break down of the materials when exposed to heat, water and pressure. The porous nature of many rigid materials allows for the growth of bacteria and fungus, which cannot be reliably removed through available cleaning methods. Such plant containers may harbor other contaminants such as cleaning solutions, which could damage a newly potted plant. The semi-rigid plant container 100 will withstand repeated washings by hand or in home or commercial dishwashers and can be cleaned reliably to avoid contamination to new potted materials. Terracotta and other porous pots are subject to mineral build up (efflorescence) on the exterior of the pot which cannot be fully removed through cleaning. This mineral buildup and potential fertilizers degrade the aesthetic appeal and creates a potential for damage to future plants planted in the affected pot. The semi-rigid plant container 100 is not subject to efflorescence, nor fertilizer degradation.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claim(s) set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in the paragraph shall apply unless so stated in this description and/or except as will be readily apparent to those skilled in the art from the description.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

1. A plant container comprising:
a base having at least one drainage opening; and
a sidewall rising from the base and presenting a top edge, an inner surface, and an outer surface,
wherein the inner surface of the sidewall and the base define a cavity configured to receive plant-growing media therein,
wherein the sidewall is formed substantially of silicone.

2. The semi-rigid plant container of claim 1, wherein said silicone is a food-grade silicone.

3. The semi-rigid plant container of claim 1, wherein the base is formed substantially of silicone.

4. The semi-rigid plant container of claim 1, wherein the base is monolithic with the sidewall.

5. The semi-rigid plant container of claim 1, wherein the sidewall is resilient so as to return to an original shape upon deformation thereof.

6. (canceled)

7. The semi-rigid plant container of claim 1,
wherein the inner surface presents a first texture,
wherein the outer surface presents a second texture,
wherein the first texture is distinct from the second texture.

8. The semi-rigid plant container of claim 7, wherein the first texture has a lower coefficient of friction than the second texture, such that the second texture is configured to allow for gripping of the outer surface.

9. The semi-rigid plant container of claim 1, further comprising:
an annular rim disposed at the top edge of the sidewall,
wherein the annular rim protrudes radially from the sidewall.

10. The semi-rigid plant container of claim 9,
wherein the annular rim is formed of silicone,
wherein the annular rim is monolithic with the sidewall.

11. The semi-rigid plant container of claim 1, wherein the base comprises a plurality of drainage openings.

12. The semi-rigid plant container of claim 1, further comprising:
a saucer configured to be disposed under the base,
wherein the saucer is configured to capture excess liquid from the at least one drainage opening.

13. The semi-rigid plant container of claim 1, wherein the base presents a circular shape.

14. The semi-rigid plant container of claim 13,
wherein the sidewall presents a conical frustum shape when viewed from an exterior side,
wherein the cavity presents a conical frustum shape.

15.-16. (canceled)

17. A plant container comprising:
a base having at least one drainage opening; and
a sidewall rising from the base and presenting a top edge, an inner surface, and an outer surface,
wherein the inner surface of the sidewall and the base define a cavity configured to receive plant-growing media therein,
wherein the sidewall is formed entirely of silicone having a Shore A hardness in the range of 40 to 100.

18. The semi-rigid plant container of claim 17, wherein the sidewall is resilient so as to return to an original shape upon deformation thereof.

19. The semi-rigid plant container of claim 17,
wherein the inner surface presents a first texture,
wherein the outer surface presents a second texture,
wherein the first texture is distinct from the second texture,
wherein the first texture has a lower coefficient of friction than the second texture, such that the second texture is configured to allow for gripping of the outer surface.

20. The semi-rigid plant container of claim 17, further comprising:
an annular rim disposed at the top edge of the sidewall,
wherein the annular rim protrudes radially from the sidewall,
wherein the annular rim is formed of silicone,
wherein the annular rim is monolithic with the sidewall.

21. A plant container comprising:
a first base having at least one drainage opening;
a second base having at least one drainage opening;
a first sidewall rising from the first base,
wherein the first sidewall and the first base define a first cavity configured to receive a first plant-growing medium therein; and
a second sidewall rising from the second base,
wherein the second sidewall and the second base define a second cavity configured to receive a second plant-growing medium therein,
wherein the first sidewall, the second sidewall, the first base, and the second base are each formed entirely of silicone having a Shore A hardness in the range of 40 to 100.

22. A method of growing a plant, said method comprising:
providing a plant container according to claim 1;
introducing a plant-growing medium into a cavity of said container;
inserting a seed or seedling into said plant-growing medium;
wherein said seed or seedling grow within said plant-growing medium.

23. The method of claim 22, further comprising emptying said cavity and sterilizing said plant container to yield a sterilized container, wherein said emptying said cavity comprises deforming said container to squeeze said plant-growing medium, seed or seedling from said cavity, wherein said container returns to an original shape after said deforming.

24.-25. (canceled)
